(19) United States
(12) Patent Application Publication
(10) Pub. No.: US 2010/0038411 A1
(43) Pub. Date: Feb. 18, 2010

(54) METHOD OF PRODUCING CONDUCTIVE CIRCUIT BOARD

(75) Inventors: Takashi Shoji, Minato-ku (JP); Takekazu Sakai, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 12/516,978

(22) PCT Filed: Dec. 3, 2007
(86) PCT No.: PCT/JP2007/073730

§ 371 Date: Jul. 21, 2009

(30) Foreign Application Priority Data
Dec. 4, 2006 (JP) 2006-326655

(51) Int. Cl. B23K 1/20

(52) U.S. Cl. 228/223; 228/248.1

(57) ABSTRACT

A conductive circuit board is produced by imparting tackiness to the conductive circuit surface on a printed wiring board, attaching solder powder to the tacky area by supplying a slurry containing solder powder, and then heating the printed wiring board to melt the solder, thereby forming a solder circuit. In the solder circuit prepared by this method, tackiness is imparted to portions of the circuit with an insufficient amount of solder attached thereto and solder powder is attached to these tacky areas, or a solder paste is applied to the portions of the circuit with an insufficient amount of solder attached, and the solder powder or solder paste is melted to rectify the solder circuit, thereby producing a conductive circuit board with little variation in the amount of solder attached.

### CROSS REFERENCE TO RELATED APPLICATION

This application is an application filed under 35 U.S.C. §111(a) claiming the benefit pursuant to 35 U.S.C. §119(e)(1) of the filing date of Japanese Patent Application No. 2006-326655 filed Dec. 4, 2006 pursuant to 35 U.S.C. §111(b).

### TECHNICAL FIELD

The present invention relates to a method of producing a solder circuit board. More specifically, the invention relates to a method of producing a conductive circuit board, wherein a solder layer is formed on the surface of a fine conductive circuit on a printed wiring board.

### BACKGROUND ART

In recent years, printed wiring boards with circuit patterns formed on an insulator substrate such as a plastic substrate, a ceramic substrate, or a metal substrate coated with a plastic or the like have been developed, and the technique of creating electronic circuits by soldering electronic components like IC devices, semiconductor chips, resistors, and condensers on the circuit pattern has been widely used.

To bond the lead terminals of such electronic components to predetermined sites on the circuit pattern, in general, a thin layer of a solder is formed in advance on the surface of a conductive circuit on a board, a solder paste or flux is printed on it, predetermined electronic components are mounted at the decided positions, and the thin solder layer or the thin solder layer and solder paste are reflowed to establish solder connections.

Recently there has been a demand for solder circuit boards of finer pitch for miniaturizing electronic products. Many fine pitch components such as 0.3 mm pitch QFP (Quad Flat Package) LSIs and CSPs (Chip Size Packages), and 0.15 mm pitch FCs (Flip Chips) are mounted. Therefore, very fine and accurate solder circuit patterns that can accommodate such fine pitch are being demanded in solder circuit boards.

Methods such as plating, HAL (Hot Air Leveling), and printing with a paste of solder powder and then reflowing it are used to form the solder circuit made of a solder film on a printed wiring board. When producing solder circuits by the plating method, however, it is difficult to form a thick solder layer, whereas achieving a fine pitch pattern is difficult with the HAL method or the solder paste printing method.

A method of forming solder circuits not requiring the cumbersome operation of aligning the circuit pattern, etc, which comprises imparting tackiness to the surface of a conductive circuit on a printed wiring board through a reaction with a tackiness-imparting compound, attaching a solder powder to these tacky parts, and then heating the printed wiring board to melt the solder and form the solder circuit, has been disclosed (refer, for example, to JP-A HEI 07-7244).

Highly reliable circuit boards with fine solder circuit patterns formed by a simple procedure can be now provided by the method disclosed in JP-A HEI 07-7244. However, since a solder powder is attached on a circuit board by a dry process, this method has problems like the solder powder getting attached by static electricity to parts where it is not required, scattering of the powder, etc, all of which prevent the production of high resolution circuit boards and efficient utilization of the powder.

Therefore, the present inventor(s) had earlier applied for patent(s) for a method of attaching the solder powder through a wet process, by immersing a printed wiring board in a slurry containing solder powder to attach the solder powder to the surface of a conductive circuit that has been made tacky (refer, for example, to JP-A 2006-278650).

In the method, described in JP-A 2006-278650, of immersing the printed wiring board in a solder powder slurry to attach the solder powder on the surface of a conductive circuit that has been made tacky, the solder powder becomes buoyant in the slurry, which reduces its adhesive power compared to the dry process. Therefore, the present inventor(s) applied for patent(s) for a method of firmly attaching a solder powder on parts of a circuit that have been made tacky, by the use of a dispenser of a solder powder slurry in which pressure is applied to the slurry (refer, for example, to the specifications of JP-A 2005-261835).

The method described in the specifications of JP-A 2005-261835 enabled firm attachment of the solder powder to conductive circuit parts. However, there has been variation sometimes in the amount of the solder powder attached on the surface of the conductive circuit on the printed wiring board. This is because the method described in JP-A 2005-261835 employs a device like a dispenser to supply the solder powder slurry as the device scans the surface of the printed wiring board, and there is variation in the scanning speed of the device or in the supply pressure in the dispenser, etc, which causes variation in the amount of the solder powder attached on the tacky parts of the conductive circuit.

The purpose of the present invention is to provide a method of rectifying parts of a solder circuit where an insufficient amount of solder is attached and reducing the variation in the amount of the solder powder attached in the formation of the solder circuit, and thus solve the aforesaid problems.

### DISCLOSURE OF THE INVENTION

The present inventors arrived at the present invention as a result of painstaking investigations aimed at solving the aforesaid problems. In short, the present invention relates to the following.

(1) A method of producing a conductive circuit board comprising imparting tackiness to a surface of a conductive circuit on a printed wiring board, supplying a slurry containing solder powder to said tacky area to attach the solder powder thereto, and then heating said printed wiring board to melt the solder to form a solder circuit, further comprising imparting tackiness to parts of the solder circuit thus formed that have an insufficient amount of the solder attached thereto, attaching a solder powder to said parts, and melting the solder powder to rectify the solder circuit.

(2) The method of producing a conductive circuit board according to (1), wherein the tackiness is imparted by application of solder flux.

(3) The method of producing a conductive circuit board according to (1) or (2), wherein solder balls are used as the solder powder.

(4) The method of producing a conductive circuit board according to one of (1) to (3), wherein a vacuum pincette is used to attach the solder powder.

(5) A method of producing a conductive circuit board comprising imparting tackiness to a surface of a conductive circuit on a printed wiring board, supplying a slurry containing solder powder to said tacky area to attach the solder powder thereto, and then heating said printed wiring board to melt the solder to form a solder circuit, further comprising applying a solder paste to parts of the solder circuit thus formed that have an insufficient amount of the solder attached thereto, and melting the solder paste to rectify the solder circuit.

(6) The method of producing a conductive circuit board according to (5), wherein a dispenser is used to apply the solder paste.

(7) The method of producing a conductive circuit board according to one of (1) to (6), wherein the melting of the solder to form the solder circuit and melting of the solder for rectifying the solder circuit are performed at a temperature that is 20 to 50° C. higher than the melting point of the solder alloy.

The present invention enables the formation of solder layers of uniform thickness on a printed wiring board that has a fine circuit pattern and minute bumps. Because of this, the circuit board mounted with electronic components can be miniaturized and made highly reliable, which enables providing electronic devices with superior characteristics.

### BRIEF DESCRIPTION OF DRAWINGS

FIG. 1 is an example of a dispenser for solder powder slurry of the present invention; and

FIG. 2 is an example of a vacuum pincette, shown holding a solder ball.

### BEST MODE FOR CARRYING OUT THE INVENTION

The present invention is described below, according to the sequence of the production process.

The printed wiring boards relevant to the present invention are one-sided printed wiring boards, two-sided printed wiring boards, multilayered printed wiring boards, flexible printed wiring boards, or the like, which have been prepared by forming a circuit pattern made of a conductive material like a metal, etc on an insulating substrate made of plastic, plastic film, glass fabric, epoxy resin-impregnated paper, a laminate of a ceramic or other substrate on a metal sheet, or a metal base material coated with plastic or ceramics, etc. Apart from this, the invention can be applied to the attachment of IC boards, condensers, resistors, coils, varistors, bare chips, wafers, etc.

Among these, it is preferable to use the present invention to create bumps for attaching BGAs (Ball Grid Arrays), and CSPs (Chip Size Packages).

In the present invention, tackiness is imparted to the surface of the conductive circuit on the aforesaid printed wiring board though a reaction with a tackiness-imparting compound, a solder powder is attached to the tacky area, and the printed wiring board is heated to melt the solder to first form a solder layer on the circuit board.

Copper is used in most cases as a conductive material to form a circuit. However, the conductive material is not limited to copper in the present invention. Any conductive material the surface of which can be made tacky by the tackiness-imparting substance discussed later can be used. Examples of such materials are substances containing Ni, Sn, Ni—Au, solder alloys, etc.

Preferable tackiness-imparting compounds in the present invention include naphthotriazole derivatives, benzotriazole derivatives, imidazole derivatives, benzimidazole derivatives, mercaptobenozothiazole derivatives, and benzothiazole thiofatty acid derivatives. These tackiness-imparting compounds have a particularly strong effect on copper, but they can impart tackiness to other conductive materials as well.

In the present invention, the benzotriazole derivative is represented by general formula (1):

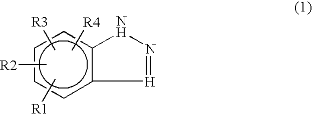

wherein each of R1 to R4 independently represents a hydrogen atom, an alkyl group or an alkoxy group having 1 to 16, preferably 5 to 16 carbon atoms, F, Br, Cl, I, a cyano group, an amino group, or an OH group.

The napthotriazole derivative is represented by general formula (2):

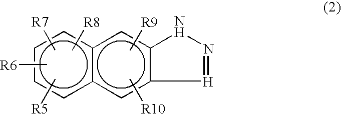

wherein each of R5 to R10 independently represents a hydrogen atom, an alkyl group or an alkoxy group having 1 to 16, preferably 5 to 16 carbon atoms, F, Br, Cl, I, a cyano group, an amino group, or an OH group.

The imidazole derivative is represented by general formula (3):

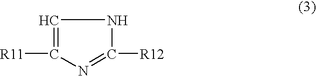

wherein each of R11 and R12 independently represents a hydrogen atom, an alkyl group or an alkoxy group having 1 to 16, preferably 5 to 16 carbon atoms, F, Br, Cl, I, a cyano group, an amino group, or an OH group.

The benzimidazole derivative is represented by general formula (4):

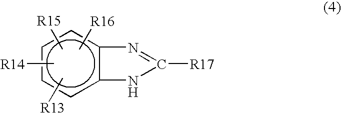

wherein each of R13 to R17 independently represents a hydrogen atom, an alkyl group or an alkoxy group having 1 to 16, preferably 5 to 16 carbon atoms, F, Br, Cl, I, a cyano group, an amino group, or an OH group.

The mercaptobenzothiazole derivative is represented by general formula (5):

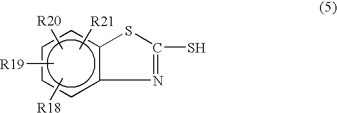

wherein each of R18 to R21 independently represents a hydrogen atom, an alkyl group or an alkoxy group having 1 to 16, preferably 5 to 16 carbon atoms, F, Br, Cl, I, a cyano group, an amino group, or an OH group.

The benzothiazole thiofatty acid derivative is represented by general formula (6):

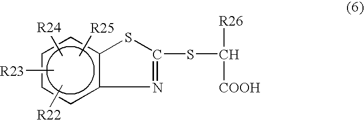

wherein each of R22 to R26 independently represents a hydrogen atom, an alkyl group or an alkoxy group having 1 to 16, preferably 1 or 2 carbon atoms, F, Br, Cl, I, a cyano group, an amino group, or an OH group.

Among these compounds, the benzotriazole derivatives represented by general formula (1) having a higher number of carbon atoms in R1 to R4 generally have higher tackiness.

Among the imidazole derivatives and the benzimidazole derivatives, respectively represented by general formula (3) and general formula (4), also those having more carbon atoms in R11 to R17 generally have higher tackiness.

Among the benzothiazole thiofatty acid derivatives represented by general formula (6), those having 1 or 2 carbon atoms in R22 to R26 are preferable.

In the present invention, at least one of these tackiness-imparting compounds, dissolved in water or acidic water preferably adjusted to weakly acidic pH of about 3 to 4, is used. When the conductive material is a metal, an inorganic acid such as hydrochloric acid, sulfuric acid, nitric acid or phosphoric acid may be used for adjusting pH. As an organic acid, formic acid, acetic acid, propionic acid, malic acid, oxalic acid, malonic acid, succinic acid, and tartaric acid may be used. Although the concentration of the tackiness-imparting compound is not strictly restricted, and the concentration needs to be adjusted, taking into account the compound's solubility and the conditions of its use, overall, the preferable range is 0.05% to 20% by mass, considering the ease in use. Concentrations lower than this will not properly form a tacky film, and therefore, are not preferable from the performance point of view.

A treatment temperature slightly higher than room temperature gives good rate and amount of tacky film formation. Although there is no restriction on the treatment temperature, which differs depending on the concentration of the tackiness-imparting compound, the type of metal, etc, 30 to 60° C. is generally the suitable range. It is preferable to adjust other conditions so that the immersion time is about 5 seconds to about 5 minutes, considering the operational efficiency, although there is no restriction on this.

In this process, coexistence of 10 to 5000 ppm of copper in the form of copper ions, in the solution is preferable, since this improves the efficiency of tacky film formation, i.e., the rate and amount of film formation.

While treating the printed wiring board with the solution of the tackiness-imparting compound, it is preferable to cover, with resist, etc, the portions of the conductive circuit that do not require solder, and expose only the required parts of circuit pattern.

Here, the conductive circuit surface will acquire tackiness, if the printed wiring board is immersed in the aforesaid tackiness-imparting compound solution, or the solution is applied to the board.

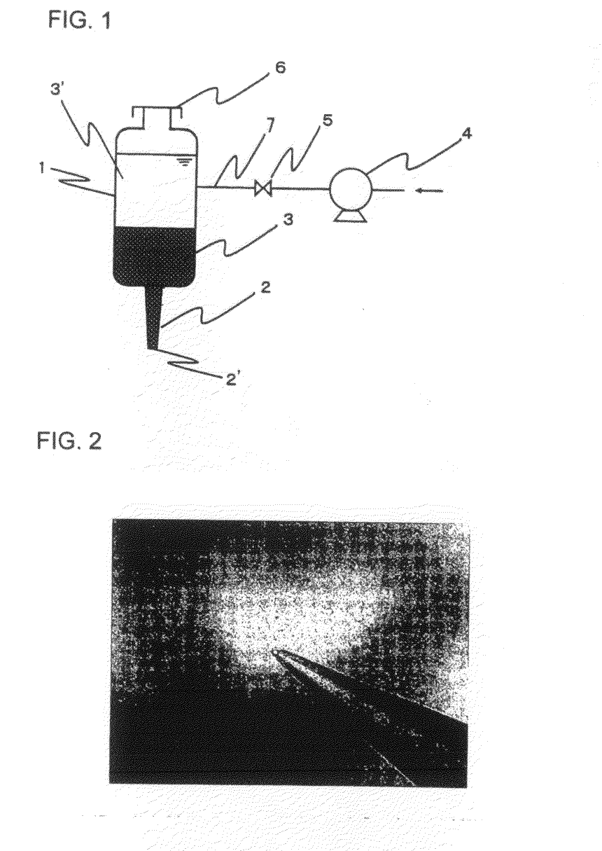

In the present invention, the solder powder is attached to the tacky parts of the conductive circuit surface, using a dispenser, for example, of the type illustrated in FIG. 1, for applying the solder powder slurry.

Immersing the printed wiring board in the slurry to attach the solder powder to the tacky parts of the circuit surface may be considered. But, as mentioned earlier, the solder powder becomes buoyant and its adhesive power becomes lesser compared to the dry process.

In the present invention, the dispenser for the solder powder slurry has, as illustrated in FIG. 1 for instance, a tank 1 for storing a slurry 3 (in FIG. 1 the slurry is shown separated into a solder powder part 3 and a solvent part 3′ in the tank), a slurry outlet pipe 2 installed on the tank, an outlet 2′ of the outlet pipe 2, and an inlet pipe 7 connected to the tank for supplying a gas like air or the solvent, and a pump 4 and an open and shut valve 5 installed on the inlet pipe and for releasing the slurry stored in the tank through the outlet. A supply inlet 6 is for supplying a solder powder slurry to the tank 1.

In the device illustrated in FIG. 1, the slurry introduced into the tank 1 from the supply inlet 6 is released through the slurry outlet 2′ by pressurizing the tank 1 with compressed air, or solvent that would become part of the slurry, supplied through the pump 4 and the open and shut valve 5. In other words, if a slurry dispenser with this structure is used, the solder powder present in the slurry does not pass through the pump or the open and shut valve, and there is no chance of the solder powder getting crushed by the mechanical parts of the pump or the open and shut valve, which can supply the solder powder with stable shape.

The solder powder slurry used in the present invention has a solder powder concentration, in the liquid, preferably in the range of 0.5% to 10% by volume, more preferably 3% to 8% by volume.

Water is preferably used as the solvent in the solder powder slurry of the present invention. The use of deoxygenated water and adding an antirust agent to the water are preferred, for preventing oxidation of the solder powder by the water. The metal composition of the solder powder used in the method of producing solder circuit boards according to the present invention can, for instance, be of the Sn—Pb, Sn—Pb—Ag, Sn—Pb—Bi, Sn—Pb—Bi—Ag, and Sn—Pb—Cd systems. Also, from the viewpoint of the recent trend of eliminating Pb from industrial wastes, Pb-free compositions like Sn—In, Sn—Bi, In—Ag, In—Bi, Sn—Zn, Sn—Ag, Sn—Cu, Sn—Sb, Sn—Au, Sn—Bi—Ag—Cu, Sn—Ge, Sn—Bi—Cu, Sn—Cu—Sb—Ag, Sn—Ag—Zn, Sn—Cu—Ag, Sn—Bi—Sb, Sn—Bi—Sb—Zn, Sn—Bi—Cu—Zn, Sn—Ag—Sb, Sn—Ag—Sb—Zn, Sn—Ag—Cu—Zn, and Sn—Zn—Bi systems are preferable.

Specific examples of the aforementioned compositions include 62Sn-36Pb-2Ag, 62.6Sn-37Pb-0.4Ag, 60Sn40Pb, 50Sn-50Pb, 30Sn-70Pb, 25Sn-75Pb, 10Sn-88Pb-2Ag, 46Sn-8Bi-46Pb, 57Sn-3Bi-40Pb, 42Sn-42Pb-14Bi-2Ag, 45Sn-40Pb-15Bi, 50Sn-32Pb-18Cd, 48Sn-52In, 43Sn-57Bi, 97In-3Ag, 58Sn-42In, 95In-5Bi, 60Sn-40Bi, 91Sn-9Zn, 96.5Sn-3.5Ag, 99.3Sn-0.7Cu, 95Sn-5Sb, 20Sn-80Au, 90Sn-10Ag, 90Sn-7.5Bi-2Ag-0.5Cu, 97Sn-3Cu, 99Sn-1Ge, 92Sn-7.5Bi-0.5Cu, 97Sn-2Cu-0.8Sb-0.2Ag, 95.5Sn-3.5Ag-1Zn, 95.5Sn-4Cu-0.5Ag, 52Sn-45Bi-3Sb, 51Sn-45Bi-3Sb-1Zn, 85Sn-10Bi-5Sb, 84Sn-10Bi-5 Sb-1Zn, 88.2Sn-10Bi-0.8Cu-1Zn, 89Sn-4Ag-7Sb, 88Sn-4Ag-7Sb 1Zn, 98Sn-1Ag-1Sb, 97Sn-1Ag-1Sb-1Zn, 91.2Sn-2Ag-0.8Cu-6Zn, 89Sn-8Zn-3Bi, 86Sn-8Zn-6Bi, 89.1Sn-2Ag-0.9Cu-8Zn, apart from the representative eutectic solder having 63% by mass of Sn and 37% by mass of Pb (hereinafter referred to as “63Sn-37Pb”). A mixture of 2 or more solder powders, each with a different composition, can also be used as the solder powder in the present invention.

As the thickness of the solder film formed can be adjusted by changing the particle size of the solder power, the particle size of the solder powder is selected according to the thickness of the solder coat to be formed. For instance, it may be selected from the powders of size ranges 63 to 22 μm, 45 to 22 μm, and 38 to 22 μm, etc, separated by sieving, as specified in Japanese Industrial Standards (JIS), and solder balls of size 63 μm or larger.

A JIS method that employs standard sieves and a balance may be normally used for measuring the mean particle size of the solder powder in the present invention. Alternatively, microscopic image analysis, or a Coulter counter, which uses the electrozone sensing method, may be employed. The principle of the Coulter counter is described in “Funtai Kogaku Binran (Powder Engineering Handbook)”, pp. 19 to 20, 2nd edition, compiled by the Powder Engineering Society. In this method, a solution in which the powder is dispersed is drawn through a small aperture on a diaphragm wall and the change in electrical resistance between the two sides of the aperture is measured to determine the particle size distribution of the powder, and the proportions of different particle sizes can be measured with high reproducibility. The mean particle size of the solder powder to be used in the present invention can be determined by one of the methods described above.

In the reflow process for the attached solder powder in the present invention, preheating is performed at a temperature of 130 to 180° C., preferably 130 to 150° C., and the preheating duration is 60 to 120 seconds, preferably 60 to 90 seconds. Reflowing is performed at a temperature that is 20 to 50° C. higher, preferably 20 to 30° C. higher, than the melting point of the alloy, and the reflow time is 30 to 60 seconds, preferably 30 to 40 seconds.

The reflow process can be performed in a nitrogen atmosphere or in air. When the reflow process is performed in nitrogen atmosphere, keeping the oxygen concentration at not more than 5% by volume, preferably not more than 0.5% by volume, improves the wettability of the solder circuit with the solder, and reduces solder ball formation, making the processing more stable compared to when the reflowing is performed in air.

A part of the present invention is the rectification of the post-reflow solder circuit formed by the method mentioned above, wherein tackiness is imparted to portions of the circuit that have an insufficient amount of solder attached thereto, solder powder is attached to the tacky parts, and then the solder powder is melted.

In the present invention, visual observation through magnifiers, and automatic identification systems that use optical or contact sensors may be employed to identify parts of the circuit with an insufficient amount of solder attached.

In the present invention, imparting tackiness to parts of the circuit with an insufficient amount of solder attached can be performed by applying a solder flux, for instance. Here, a solder flux means resin components such as rosin mixed with a thixotropic agent, a solvent, etc.

In the present invention, the melting of the solder powder can be performed under the same conditions as descried above, i.e., at a temperature that is 20 to 50° C. higher, preferably 20 to 30° C. higher than the melting point of the alloy used, and a reflow time of 30 to 60 seconds, preferably 30 to 40 seconds.

It is preferable to use a vacuum pincette in the present invention for attaching the solder powder to the portions of the circuit with an insufficient amount of solder attached. Here, vacuum pincette is a device in which a pen-shaped main body has a pad at its tip for vacuum adhesion of powder, etc, and a mechanism that creates a vacuum inside the body when the powder, etc needs to be held at the tip of the body and removes the vacuum when the powder, etc needs to be released. FIG. 2 illustrates an example where a solder ball is held at the tip of a vacuum pincette.

In the present invention, it is preferable to use solder balls as the solder powder for rectifying the portions of the circuit with an insufficient amount of solder attached. Solder balls are a form of spherical solder particles produced by atomization or the like. Because of its spherical shape, a solder ball can be conveniently held at the tip of the vacuum pincette and is suitable for rectifying portions of the circuit using the vacuum pincette.

In another method of the present invention, rectification of the portions of the circuit with insufficient amount of solder attached is performed by applying a solder paste to such portions, and melting the solder paste.

Solder paste means a paste produced by mixing solder powder and flux together. An example of a flux is a mixture of 20 to 60% by mass of a resin component such as rosin, 0.04 to 20% by mass of a thixotropic agent, 0.01 to 20% by mass of an organic acid component, 0.02 to 20% by mass of an organic halogen compound, and 0.05 to 20% by mass of a reducing agent, all with respect to the total amount of the flux, the remainder being the solvent. A solder paste can be prepared by mixing together, for example, 14 to 8% by mass of this type of flux, and 86 to 92% by mass of a solder powder, both with respect to the total amount of the solder paste. A device like a planetary mixer is used for the mixing.

In the present invention, rectifying portions of the circuit with the aforesaid solder balls is easy from the operational point of view, as the solder balls can be conveniently held at the tip of the vacuum pincette. However, for attaching the solder balls to portions of the circuit, tackiness needs to be imparted beforehand to those portions. Contrary to this, the method that uses a solder paste for rectifying portions of the circuit does not require prior imparting of tackiness to those portions, as the solder paste itself has tackiness. Therefore, the process can be simplified. Besides, in the method of rectifying using a solder paste, the amount of solder supplied can be regulated by adjusting the amount of solder paste, whereas in the method using solder balls, the amount of solder supplied depends on the size of the solder balls.

In the present invention, the use of a dispenser is preferable for applying the solder paste to rectify the portions of the circuit with an insufficient amount of solder attached. Here, dispenser means a hypodermic syringe-like device that can deliver a certain amount of liquid substance, which enables precise control of the amount delivered and precise alignment of the delivery site. The use of such a device enables the application of an amount of solder paste suitable for correcting the deficiency to very precise locations at portions of the circuit with insufficient amount of solder attached.

The solder circuit board prepared according to the present invention can be suitably used for mounting of electronic components, which involves mounting of the electronic components and bonding them to the board by reflow soldering. With the solder circuit boards prepared according to the present invention, for instance, the solder paste can be applied by printing, etc to the parts where the electronic components are to be attached, the electronic components placed at the required sites, heat applied to melt the solder powder in the solder paste, and the solder solidified to bond the electronic components to the circuit board.

The surface mounting technique (SMT) may be used, for instance for bonding (mounting) the solder circuit board with electronic components. In the SMT, a solder circuit board is first prepared according to the present invention or by printing a solder paste. The solder paste is applied, for instance, to the desired sites on the circuit pattern. Next, the electronic components such as chips and QFPs, to which the solder has been attached or reflowed according to the present invention, are mounted on the solder paste on the circuit pattern and solder-bonded collectively by reflow heating. A hot air oven, infrared oven, vapor condensation soldering apparatus, optical beam soldering machine, etc can be used as the reflow heat source.

The present invention is described below citing an example, without intending to restrict the scope of the invention.

### EXAMPLE

A printed wiring board with a minimum electrode spacing 50 μm and an electrode diameter 80 μm was prepared. The conductive circuit was made with copper.

A 2% by mass aqueous solution of an imidazole compound represented by general formula (3) wherein R12 is a C₁₁H₂₃ alkyl group and R11 is a hydrogen atom, the pH of which was adjusted to about 4 with acetic acid, was used as the tackiness-imparting compound solution. This aqueous solution was heated to 40° C., and the printed wiring board, which had been pretreated with aqueous hydrochloric acid, was immersed in the heated solution for 3 minutes to form a tacky substance on the surface of the copper circuit.

A solder powder slurry was prepared by mixing about 20 g of 96.5Sn-3.5Ag solder powder with a mean particle size of 70 μm (measured by a microtrack method) in about 100 g of deoxygenated pure water.

A device with the structure illustrated in FIG. 1 was used as the dispenser for the solder powder slurry.

The solder powder slurry prepared above was placed in the tank shown in FIG. 1 and the outlet was set on the board to which tackiness had been imparted. The open and shut valve was then opened and the dispenser run over the board surface to discharge the solder powder slurry to cover the circuit.

The excess solder powder on the board was washed off with pure water, and the board dried.

The washed out solder powder was recovered and recycled for solder powder attachment.

This printed wiring board was then placed in a 240° C. oven and the solder powder melted to form about 50 μm thick bumps of 96.5Sn-3.5Ag solder on the exposed parts of the copper circuit.

Observation through a magnifier of the printed wiring board thus produced revealed that solder bump formation was insufficient at 3 out of 200 electrode sites. To be specific, the height of these solder bumps was insufficient. A rosin type flux was applied to these 3 electrode sites and 150 μm diameter solder balls were attached using the vacuum pincette illustrated in FIG. 2. The attached solder balls were then melted with a thermal beam focused with a lens, to complete the rectification of the printed wiring board.

### INDUSTRIAL APPLICABILITY

The present invention enabled the production of electronic circuit boards with remarkably improved reliability, having a uniformly thick solder layer even when the circuit pattern is very fine, and solder bumps of uniform height. As a result, miniaturization and high reliability of circuit boards having fine circuit patterns with highly reliable electronic components mounted on them was able to be realized. Thus the invention enabled the providing of electronic circuit boards, highly reliable circuit boards with high mounting density of electronic components, and electronic devices with superior characteristics.

1. A method of producing a conductive circuit board comprising imparting tackiness to a surface of a conductive circuit on a printed wiring board, supplying a slurry containing solder powder to the tacky area to attach the solder powder thereto, and then heating said printed wiring board to melt the solder to form a solder circuit, further comprising imparting tackiness to portions of the solder circuit thus formed that have an insufficient amount of the solder attached thereto, attaching a solder powder to said portions, and melting the solder powder to rectify the solder circuit.

2. The method of producing a conductive circuit board according to claim 1, wherein the tackiness is imparted by application of solder flux.

3. The method of producing a conductive circuit board according to claim 1, wherein solder balls are used as the solder powder.

4. The method of producing a conductive circuit board according to claim 1, wherein a vacuum pincette is used to attach the solder powder.

5. A method of producing a conductive circuit board comprising imparting tackiness to a surface of a conductive circuit on a printed wiring board, supplying a slurry containing solder powder to said tacky area to attach the solder powder thereto, and then heating said printed wiring board to melt the solder to form a solder circuit, further comprising applying a solder paste to portions of the solder circuit thus formed that have an insufficient amount of the solder attached thereto, and melting the solder paste to rectify the solder circuit.

6. The method of producing a conductive circuit board according to claim 5, wherein a dispenser is used to apply the solder paste.

7. The method of producing a conductive circuit board according to claim 1, wherein the melting of the solder to form the solder circuit and melting of the solder for rectifying the solder circuit are performed at a temperature that is 20 to 50° C. higher than the melting point of the solder alloy.
